(19) United States
(12) Patent Application Publication
(10) Pub. No.: US 2006/0241874 A1
(43) Pub. Date: Oct. 26, 2006

(54) Monitoring system

(76) Inventor: Peter John Carter, Mt. Eliza (AU)

Correspondence Address: MERCHANT & GOULD PC, P.O. BOX 2903, MINNEAPOLIS, MN, 55402-0903, US

(21) Appl. No.: 10/533,270

(22) PCT Filed: Sep. 12, 2003
(86) PCT No.: PCT/AU03/01198

§ 371 Date: Mar. 7, 2006

(30) Foreign Application Priority Data
Oct. 31, 2002 (AU) 2002952554

(51) Int. Cl. G06F 19/00

(52) U.S. Cl. 702/50

(57) ABSTRACT

A monitoring system for monitoring fluid used in an environment such as a trade/industrial waste plant or air conditioning cooling tower installation is disclosed. The system includes sensors (26 to 34, 53 to 55) for sensing parameters of the fluid, a remote monitoring system (40) for receiving signals indicative of the measured parameters from the sensors and for applying rules to the signals to determine whether the signals meet predetermined criteria so that an event indication can be generated if the predetermined criteria are not met. The system (40) includes a processor (41) and a memory (42). The system (40) is connected to a central station (72) by a communication link (74). The central station (72) includes a server (80) and data store (82) which are connected to the Internet so the data can be interrogated by a user via a PC (86). The system also generates an audible or visual alarm (62) or forwards a message to authorised personnel via SMS message to a mobile telephone (87) or by e-mail in the case of an event condition being generated. A user is able to log onto the system and interrogate data retained in the system relating to the user's sites to determine the operating parameters of the system and also to determine problems if an event indication is established.

### FIELD OF THE INVENTION

This invention relates to a monitoring system for monitoring environments such as trade/industrial waste water plants or cooling towers used in air conditioning systems for buildings.

### BACKGROUND ART

Many environments exist in which various types of fluids need to be monitored to determine particular characteristics of the fluid to, for example, determine whether the fluids are suitable for discharge to drain or whether the fluids are of such a character that they are suitable for the intended purpose and do not show signs of becoming contaminated.

Two such environments in which monitoring of fluids is required are trade/industrial waste water plants in which waste water is collected, processed and then discharged to drain, and also water used in cooling towers used in air conditioning systems for buildings and like premises.

Waste water plants generally receive waste water from a variety of sources and the water is processed to ensure that it is safe to discharge to the environment, and therefore will not create an environmental hazard. In the case of cooling towers, it is essential that the water in the cooling towers be monitored so as to ensure that an environment in which the pathogen which causes legionnaire's disease can flourish, is not established.

One major problem with current monitoring techniques to determine the state of fluid used in these environments is that the monitoring is not ongoing and is generally only conducted on an ad hoc or periodical basis.

Whilst some systems do provide ongoing monitoring, the problem with these systems is that the results of monitoring are not in a form which can be easily inspected and interpreted, and therefore considerable time may be needed in analysis in order to determine whether a problem does exist. Obviously, once the analysis has been completed and the time period passed, the damage caused by the inappropriate conditions may have already occurred and not be reversible.

Thus, whilst testing may show that the water is suitable for the intended purpose, it may be that the characteristics of the water has changed significantly between measurement times, and whilst was within satisfactory limits at the measurement times, was not at these levels during various periods between measurements. Thus, the water may have acquired characteristics which make the water unsuitable for discharge to the environment in the case of trade and industrial waste water plants, or in which legionnaire can flourish in the case of air conditioning cooling towers.

### SUMMARY OF THE INVENTION

The object of the invention is to provide a monitoring system which overcomes this problem.

The present invention provides a monitoring system for monitoring a fluid at a site, comprising:

at least one sensor for monitoring the fluid and providing data indicative of a characteristic of the fluid;

a processor associated with the site for receiving the data from the sensor and for storing the data in a storage, the processor being programmed with predetermined rules and being for applying the predetermined rules to determine if the data, and therefore the characteristic of the fluid, meets a predetermined criterion, and being for determining whether the data needs to be transmitted to a centralised control station;

a communication device for establishing a data transmission link between the processor and the centralised control station and for transmitting the data over the link so the data can be transmitted in bulk when the rules determine the data needs to be transmitted to the station;

a server and a data store at the centralised control station for receiving and storing the data for utilisation by a user over the Internet; and

an event indicator for providing an indication if the predetermined criterion is not met so remedial action can be taken.

The invention also provides a method of monitoring a fluid at a site, comprising the steps of:

monitoring the fluid with at least one sensor to provide data indicative of a characteristic of the fluid;

storing the data and processing the data at the site in accordance with predetermined rules to determine if the data, and therefore the characteristic of the fluid, meets a predetermined criterion, and for determining whether the data needs to be transmitted to a centralised control station;

establishing a data transmission link between the processor and the centralised control station and transmitting the data over the link so the data is transmitted in bulk when the rules establish the data needs to be transmitted to the station;

receiving the transmitted data with a server and a data store at the centralised control station so the data can be utilised by a user via the Internet; and

providing an event indication if the predetermined criterion is not met so remedial action can be taken.

Thus, the present system provides continuous and real time monitoring so that in the event of the fluid characteristic falling outside the required criterion, an event indication can be immediately given so that remedial action can be taken to correct the situation.

Preferably the event indicator comprises an alarm at the site which is activated under control of the processor if the predetermined criterion is not met.

Preferably the processor is also for, in the event of determining that the characteristic of the fluid does not meet a predetermined criterion, transmitting data via the link to the centralised control station, and the event indicator also comprising a communication processor at the centralised control station for transmitting a message to an authorised person that the predetermined criterion has not been met.

Preferably the event indicator comprises an audible or visual alarm which is activated to indicate that the characteristic falls outside the predetermined criterion.

Preferably the message comprises a mobile telephone message forwarded to a mobile telephone of the person or an SMS message forwarded to the mobile telephone, or an e-mail message.

Preferably the communication link comprises a mobile telephone data communication link.

Preferably a plurality of sensors are provided for monitoring the fluid and providing a plurality of signals indicative of different characteristics of the fluid.

Preferably the fluid comprises waste water in a trade-industrial waste water plant, water within a cooling system of an air conditioning plant, or air within a refrigeration system.

Preferably the programmed rules provide that data is transmitted in bulk when the storage is 80% full.

The invention also provides a monitoring system for a trade/industrial waste water plant which has a collection tank for collecting waste water, a mixing tank for receiving the waste water from the collection tank and in which the pH of the waste water is adjusted, a settling tank for receiving the waste water from the mixing tank, the settling tank having a pump for pumping the waste water from the settling tank to drain, the system comprising:

a sensor for measuring the pH level of the waste water in the mixing tank or the settling tank, and for providing data indicative of the pH level;

a processor at the plant for receiving the data from the sensor and for storing the data in a storage, the processor being programmed with predetermined rules and being for applying the predetermined rules to determine if the data, and therefore the pH level, meets a predetermined criterion, and being for determining whether the data needs to be transmitted to a centralised control station;

a communication device for establishing a data transmission link between the processor and the centralised control station and for transmitting the data over the link so the data can be transmitted in bulk when the rules determine the data needs to be transmitted to the station;

a server and data store at the centralised control station for receiving and storing the data so the data can be utilised by a user via the Internet; and

an event indicator for providing an indication if the pH level does not meet the predetermined criterion so remedial action can be taken.

The invention also provides a method of monitoring a trade/industrial waste water plant which has a collection tank for collecting waste water, a mixing tank for receiving the waste water from the collection tank and in which the pH of the waste water is adjusted, a settling tank for receiving the waste water from the mixing tank, the settling tank having a pump for pumping the waste water from the settling tank to drain, the method comprising the steps of:

measuring the pH level of the waste water in the mixing tank or the settling tank with a sensor, and providing data indicative of the pH level;

storing the data and processing the data at the plant in accordance with predetermined rules to determine if the data, and therefore the pH level, meets a predetermined criterion, and for determining whether the data needs to be transmitted to a centralised control station;

establishing a data transmission link between the processor and the centralised control station and transmitting the data over the link in bulk when the rules determine the data needs to be transmitted to the station;

receiving the transmitted data with a server and data store at the centralised control station so the data can be utilised by a user via the Internet; and

providing an event indication if the pH level does not meet the predetermined criterion so remedial action can be taken.

Preferably the system further comprises:

a sensor for measuring the water level in the settling tank and for providing data indicative of the water level;

a sensor for sensing flow from the pump and for providing data indicative of flow from the pump; and

wherein the processor receives the data from all the sensors to determine if the pH level, water level and flow meet predetermined criteria so that data relating to all the sensors is able to be transmitted to the centralised control station by the transmission link for receipt by the server and data store, and so the event indicator can provide an indication if the predetermined criterion relating to any one of the sensors is not met so remedial action can be taken.

Preferably the plant further comprises:

a reservoir for providing an acid solution to the mixing tank;

a reservoir for providing an alkaline solution to the mixing tank; and

the system further comprises:

respective sensors for measuring the level of the solutions in the acid reservoir and alkaline reservoir and providing signals indicative of the levels;

the processor being for receiving the signals to determine whether the level of the acid solution and alkaline solution meets predetermined criteria; and

the event indicator providing an indication if the predetermined criteria are not met so that the reservoirs can be refilled if necessary.

Preferably a first sensor is provided for measuring the pH level in the mixing tank, and a second sensor is provided for measuring the pH level in the settling tank, each for providing respective data indicative of pH level for receipt by the processor.

Preferably the processor controls the pump so as to activate the pump to pump waste water from the settling tank when the water level in the settling tank reaches a predetermined level.

Preferably the system also includes a temperature sensor for measuring the temperature of the waste water in the settling tank.

Preferably the processor controls application of acid solution or alkaline solution to the mixing tank depending on the pH level of the water.

Preferably the rules implemented by the processor include one or more of the rules selected from the following group: the temperature of the waste water, the pH level of the waste water, whether the pump is operating, the flow rate of waste water discharge by the pump, whether the central controller has made contact with the remote monitoring processor via the communication link within a specified time period, and whether the remote monitoring processor is ready to download data to the central control station.

Preferably the event indicator provides an indication of the need to turn on or off the pump, replenish the acid solution or alkaline solution in the acid reservoir and alkaline reservoir, instigate a local alarm, transmit a message to the authorised person, and download data from the remote monitoring processor to the central controller.

Preferably data is transmitted in bulk when the storage is 80% full.

The invention also provides a monitoring system for cooling towers of an air conditioning system, the monitoring system comprising:

a sensor for sensing the pH level of water in the cooling tower, and providing data indicative of the pH level;

a sensor for measuring the temperature of the water in the cooling tower, and providing data indicative of the temperature;

a sensor for measuring the conductivity of the water in the cooling tower, and providing data indicative of the conductivity;

a processor associated with towers for receiving the data from the sensors, storing the data in a storage, and for applying predetermined rules to determine whether the pH level, temperature and conductivity fall within prescribed limits, and for determining whether the data needs to be forwarded to a centralised control station;

a communication device for establishing a data transmission link between the processor and the centralised control station and for transmitting the data over the link so the data can be transmitted in bulk when the rules determine the data needs to be transmitted to the station;

a server and a data store at the centralised control station for receiving and storing the data for utilisation by a user via the Internet; and

an event indicator for providing an indication if the prescribed limits are not met so remedial action can be taken.

The invention also provides a method of monitoring cooling towers of an air conditioning system, the method comprising:

sensing the pH level of water in the cooling tower, and providing data indicative of the pH level;

measuring the temperature of the water in the cooling tower, and providing data indicative of the temperature;

measuring the conductivity of the water in the cooling tower, and providing data indicative of the conductivity;

storing and processing the data at the cooling towers in accordance with predetermined rules to determine whether the pH level, temperature and conductivity fall within prescribed limits, and for determining whether the data needs to be forwarded to a centralised control station;

establishing a data transmission link between the processor and the centralised control station and transmitting the data over the link so the data can be transmitted in bulk when the rules determine the data needs to be transmitted to the station;

receiving the transmitted data by a server and a data store at the centralised control station for utilisation by a user via the Internet; and

providing an indication event if the prescribed limits are not met so remedial action can be taken.

Preferably the data is transmitted in bulk when the storage is 80% full.

The invention also provides a monitoring system for monitoring a refrigeration unit, the monitoring system comprising:

a sensor for sensing air temperature within the unit and providing data indicative of the air temperature;

a processor at the unit for receiving the data from the sensor and for storing the data, the processor being programmed with predetermined rules and being for applying the predetermined rules to determine if the data, and therefore the air temperature, meets a predetermined criterion, and being for determining whether the data needs to be transmitted to a centralised control station;

a communication device for establishing a data transmission link between the processor and the

centralised control station and for transmitting the data over the link so the data is transmitted in bulk when the rules determine the data needs to be transmitted to the station;

a server and a data store at the centralised control station for receiving and storing the data so the data can be utilised by a user via the Internet; and

an event indicator for providing an indication if the criteria is not met so remedial action can be taken.

The invention also provides a method of monitoring a refrigeration unit, the method comprising:

sensing air temperature within the unit and providing data indicative of the air temperature;

storing and processing at the unit the data in accordance with predetermined rules to determine if the data, and therefore the air temperature, meets a predetermined criterion, and for determining whether the data needs to be transmitted to a centralised control station;

establishing a data transmission link between the processor and the centralised control station and transmitting the data over the link so the data is transmitted in bulk when the rules determine the data needs to be transmitted to the station;

receiving the transmitted data by a server and a data store at the centralised control station for so the data can be utilised by a user via the Internet; and

providing an event indication if the criteria is not met so remedial action can be taken.

Preferably the data is transmitted in bulk when the storage is 80% full.

### BRIEF DESCRIPTION OF THE DRAWINGS

Preferred embodiments of the invention will be described, by way of example, with reference to the accompanying drawings in which:

FIG. 1 is a schematic view of a trade/industrial waste water plant and an air conditioning cooling tower system according to embodiments of the invention;

FIG. 2 is a diagram of the monitoring system according to the preferred embodiment of the invention;

FIG. 3 is a flowchart explaining operation of a remote monitoring processor used in the preferred embodiment of the invention; and

FIG. 4 is a flowchart explaining user access to data acquired by the system according to the preferred embodiment of the invention.

### DETAILED DESCRIPTION OF THE PREFERRED EMBODIMENTS

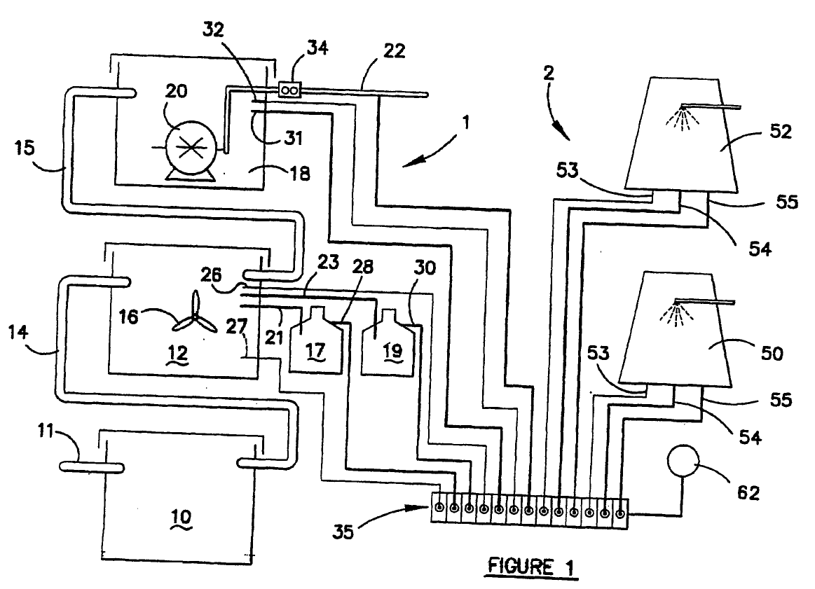

FIG. 1 is a view of both a trade/industrial waste water plant 1 and a cooling tower installation 2 for an air conditioning system of a building. However, it should be understood that the present invention is applicable to monitoring only either the waste water plant or the cooling tower installation on its own, or if the waste water plant and the cooling tower installation are both utilised at a particular site, both the plant and installation could be monitored concurrently by the same system.

The waste water plant comprising a collection tank 10 which collects waste water from a trade or industrial site (not shown) at inlet 11. Waste water from the collection tank 10 is gravity fed to a mixing tank 12 via a pipe or conduit 14. The mixing tank 12 includes a mixing vane 16. An acid reservoir 17 and an alkaline reservoir 19 are provided for supplying acid solution and alkaline solution respectively to the mixing tank 12 to adjust the pH level of the waste water in the mixing tank. The waste water in the mixing tank is gravity fed via pipe 15 to a settling tank 18 which includes a pump 20 for discharging the waste water to drain via a conduit or pipe 22.

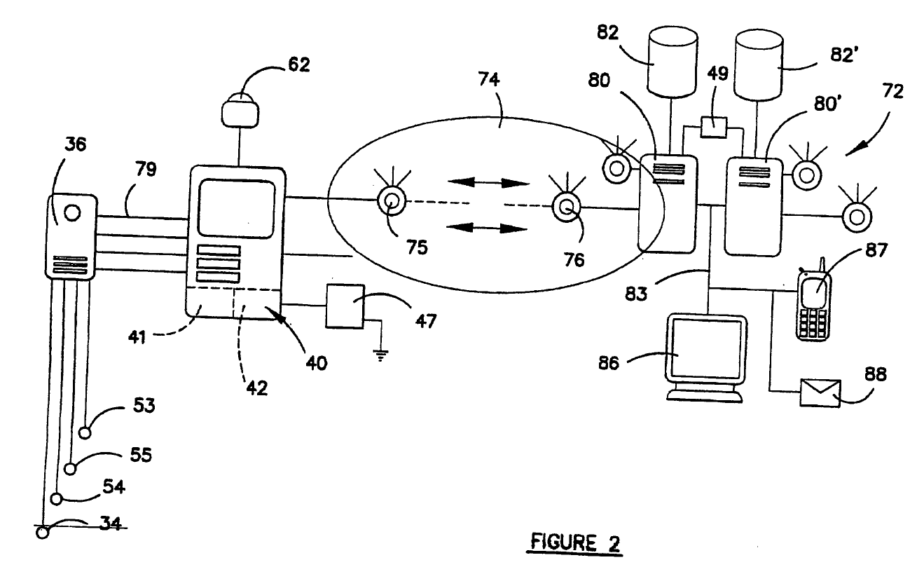

The mixing tank 12 includes a pH sensor 26 for monitoring the pH level of the waste water in the tank 12. The reservoirs 17 and 19 also include liquid level sensors 28 and 30 for monitoring the liquid level of the acid solution and the alkaline solution in the reservoirs 17 and 20. The settling tank 20 includes a liquid level sensor 31 for monitoring the level of the waste water in the settling tank 18 and also a pH sensor 32 for measuring the pH level of the waste water in the settling tank 18. The flow sensor 34 is provided for monitoring the flow of water from the pump 20. A temperature sensor 27 may be provided in the mixing tank 12 or the settling tank 18 for providing a measure of the temperature of the water in those tanks. This temperature measurement may be used to provide a correction for the pH level which is measured by the pH sensors because the pH reading attained by the sensors may change dependent on the temperature of the water within the tanks 12 and 18. The sensors 26, 27, 28, 30, 31, 32 and 34 are connected to input ports 35 of a preamplifier 36 (see FIG. 2). The preamplifier 36 is connected to a remote monitoring system 40 which includes a remote monitoring processor and a memory 42.

In the case of a cooling tower installation 2 which, for example, includes a first cooling tower 50 and a second cooling tower 52, each of the cooling towers is provided with a pH sensor 53, a temperature sensor 54 and a conductivity sensor 55 for measuring the pH level, temperature and conductivity of water used in the cooling towers 50 and 52. The sensors 53 to 55 of each of the towers 50 and 52 are connected to appropriate input ports 35 of the preamplifier 36.

Obviously, depending on the number of input ports in the preamplifier 36, all of the sensors referred to above could be connected to a single preamplifier 36 or, alternatively, a number of separate preamplifiers could be utilised, all of which are connected to either a single remote monitoring system 42 or to individual remote monitoring systems 42.

An onsite warning alarm 62 is schematically shown in FIG. 1 and is connected to the remote monitoring processor 41 as shown in FIG. 2.

The remote monitoring system 40 is powered by a suitable power supply 47 which may be conventional AC power supply, battery power supply or solar power, etc. FIG. 2, by way of example, shows four sensors connected to the preamplifier 36 and, for example, those sensors may comprise a pH sensor 53, conductivity sensor 55, temperature sensor 54, a flow sensor 34. It should be understood that these sensors are shown merely by way of example in FIG. 2 and merely represent some of the numerous sensors which can be used in the plant and installation described with reference to FIG. 1. It should also be understood that the sensors described with reference to FIG. 1 are not exhaustive and other sensors could also be utilised depending on the characteristics of the water in the plant or cooling tower installation which are required to be monitored by a particular customer. The sensors referred to in FIGS. 1 and 2 are continuously providing signals to the preamplifier 36 and to the remote monitoring system 42 to provide a continuous indication of the respective parameter they measure. Thus, the processor 41 is continuously updated with data relating to those characteristics.

The data is analysed in the processor 41 in accordance with predetermined rules which will be described in more detail hereinafter, and the data is stored in memory 40. If the predetermined rules determine that various characteristics fall outside predetermined criteria governed by the rules, then depending on the characteristic concerned, the site alarm 62 may be activated to provide an audible or visual alarm to alert maintenance personnel to the existence of a problem which requires immediate rectification.

The remote monitoring system 42 is connected to a centralised control station 72 via a communication link 74. The communication link may comprise a cellular telephone link, fixed landline or any other suitable communication link. In the preferred embodiment, the link is a cellular telephone link and a cellular modem 75 is connected to the system 42 for transmitting by way of cellular telephone call the data stored in the memory 42 to modem 76 associated with the station 72.

Typically, a user of the system may operate a number of sites 1 or 2, and each of those sites will have associated with it its own set of sensors and remote monitoring system 40. Each of the systems 40 will communicate with a single central station 72 by way of the communication link 74 so that data from all of those sites is downloaded to the system 72 for interrogation by the user and for generating alarm messages, should that be necessary.

The station 72 comprises a server 80 and a data store 82. To provide backup, a second server 80′ and data store 82′ may also be provided. The server 80 (and 80′) is connected to the Internet 83 so that data stored in the data store can be interrogated via the Internet from a PC 86 as required by authorised personnel such as maintenance staff or the like. If the processor 41 determines that sensed parameters of the plant or installation fall outside the predetermined criterion, such an event may be signalled either by the alarm 62 as previously mentioned, or alternatively or as well as the alarm 62 by sending a message to an authorised personnel such as the maintenance supervisor or the like. This message can be sent direct from the remote system 42 or from the centralised control station 72. The message may comprise a mobile telephone message compiled by the processor 41 or by a communication processor 49 at the server 80 and transmitted by way of SMS message or conventional voice message to the authorised person's mobile telephone 87. Alternatively, the message may be forwarded by way of an e-mail message 88 to the person's e-mail address.

Thus, if an event is indicated which requires some remedial action, this can therefore be attended to in response to the alarm 62 or the message forwarded to the mobile telephone 87 or the e-mail message. Thus, changes in the characteristic of the waste water in the trade/industrial waste water plant or the cooling towers can immediately be investigated and corrected to prevent the discharge of unsatisfactory water to drain or the establishment of an environment in the cooling towers 50 and 52 which enable legionnaire bacteria to flourish.

In the case of the waste water plant 1, the remote monitoring system 42 also controls operation of the plant in response to parameters sensed by the sensors 26 to 34. For example, should the pH of the waste water in the mixing tank 12 or settling tank 18 not be within the required limits, acid solution or alkaline solution is dispensed from the reservoirs 17 and 19 via conduits or pipes 21 and 23 to correct the pH level of the solution. When the liquid level in the settling tank 20 reaches a predetermined level as measured by the sensor 31, the pump 20 can be activated to pump the waste water to drain. Thus, the sensors are able to provide an indication to the remote monitoring processor 41 of the control of the pH level and the pumping of the water to drain. If the pH level is not within the required limits the pump 20 is prevented from operating by the system 40 so the water is not released to the environment. If, for example, the pH level should not be corrected over a predetermined time period, then an event condition is established which may prompt either the alarm 62 at the site or the message being sent to the authorised person so that the appropriate remedial action can be taken. This may involve complete shutdown of the plant until the problem is corrected, or whatever adjustment is necessary to ensure that the pH level is corrected. This may necessitate repair to the system which provides the acid or alkaline solution from the reservoirs 17 and 19. Furthermore, if the water level sensed by the sensor 31 reaches the predetermined level that the flow sensor 34 does not sense flow of water to drain, then an indication that the pump 20 is not operating can be established and again, the appropriate message sent so that remedial action is taken.

If the sensors 28 and 30 measure that the acid solution or alkaline solution is below a predetermined level, an indication can be given to indicate that the reservoirs 17 and 19 need to be refilled. Refilling may take place automatically from time to time without the establishment of an event condition, but the event condition enables remedial action to be immediately taken should the liquid level drop to a predetermined level between routine refills of the reservoirs 17 and 19.

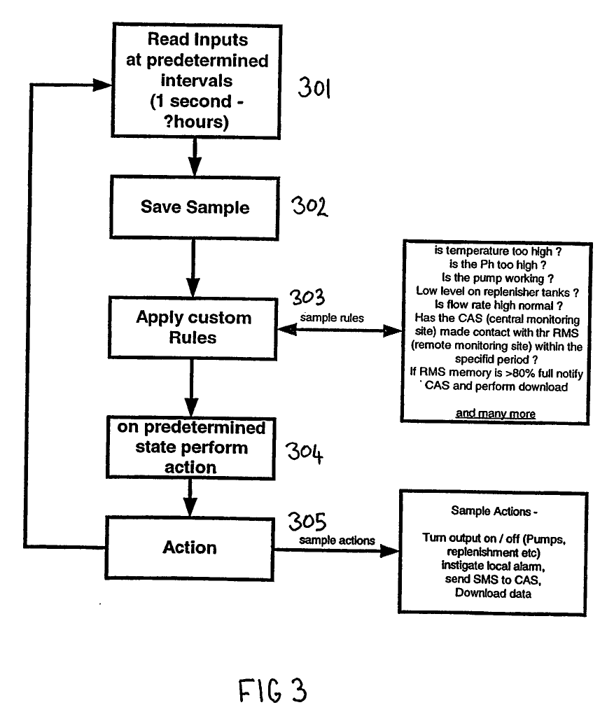

FIG. 3 is a flowchart explaining operation of the remote monitoring system 40. With reference to FIG. 3, at step 301 the inputs to the preamplifier 36 are read at predetermined intervals, such as any time interval between one second and maybe up to one or more hours, depending on the nature of the plant or installation which is being monitored. Signals supplied from the sensors are supplied via the preamplifier 36 and lines 79 to the processor 41 and the processor 41 stores those indicative signals in memory 40 as per step 302.

At step 304 the rules programmed into the processor 40 are applied to the data supplied at step 302 to determine whether the characteristics of the waste water in the plant 1, or the characteristics of the water in the cooling tower installation 2 are satisfactory. For example, with reference to the plant 1, the rules may require a determination of whether the temperature of water in the tank 18 is too high, whether the pH level sensed by the sensors 31 and 26 is too high, whether the solution level in the reservoirs 18 and 20 is low and requires replenishment, whether the pump 20 is turned on when the water level sensed by the sensor 31 is at the predetermined level so that there is flow via the flow sensor 34 and whether that flow is at the prescribed rate or below a prescribed rate. If any of these monitored conditions do not meet the rules programmed into the processor 41, then an event indication is signalled in one of the methods referred to above.

Furthermore, the rules may govern the communication between the remote monitoring system 40 and the central station 72 and, in particular, whether the central station 72 has made contact with the remote system 42 within a specified period, and also whether the memory 42 is greater than, for example, 80% full, thereby requiring download of the data from the memory 42 to the server 80 and for storage in the data store 82. At step 304, a determination, in response to the application of the rules to the data, is made as to whether any action is required and, if so, at step 305 the event indication is signalled either by way of the local alarm 62 or the message transmitted to the mobile telephone 87 or by e-mail, as indicated by reference 88 in FIG. 2.

In response to those event indications, remedial action required may be given in the telephone message or the e-mail message, or the authorised person may need to log on to the system in order to determine the remedial action required. The remedial action may include the turning on manually of the pump 20 if the pump has not automatically been switched on, the turning off of the pump 20 if the event is such that it is undesirable to discharge water to drain, or shut down of the complete system should that be necessary, all of which may require manual intervention by the authorised person. The event may also be an automatic event which is performed under the control of the system 40, such as the download of data to the system 72, as well as the activation of the local alarm 62 or the decision to send the message by way of SMS message to the telephone 87 or by e-mail.

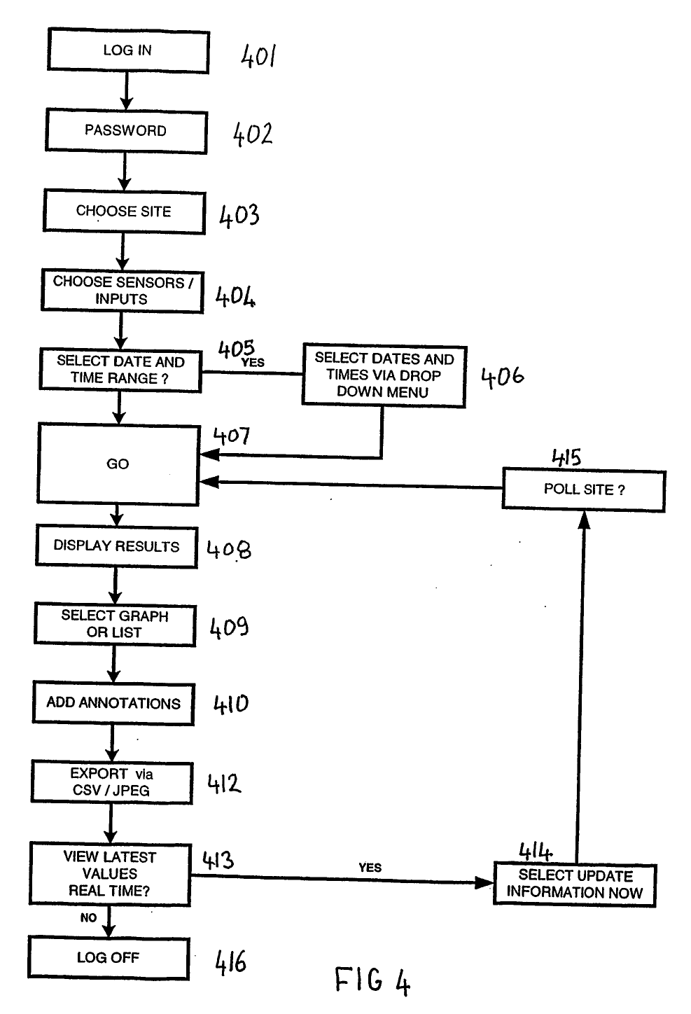

FIG. 4 is a flowchart explaining how a user may interrogate the system via the Internet from a PC 86. Typically, a user of the system may have a number of plants or buildings which are being monitored by separate sensors and remote monitoring systems 42 at each of the various sites. All of those sites will communicate via the remote monitoring system at that site to the central system 72 via the communication network 74 previously described and, as also previously described, all of the data measured by those systems is downloaded and stored in the data store 82.

When the authorised person wishes to interrogate the data, the user goes to the appropriate web page and logs in as per step 401. A password may need to be provided at 402 to provide access and this will then bring up all of the sites associated with that particular password (and therefore that particular user). The authorised person then may choose the particular site he or she wishes to investigate at step 403, and at step 404 the user can choose which of the various sensor inputs at that site the user would like to interrogate. This may, for example, simply be a pH level in the cooling towers 50 and 52 or the liquid level in the settling tank 20 or the like. Alternatively, the user can select all sensor inputs if the user wishes to consider all of the inputs.

At step 405 the user has the ability to select a particular date and time range the user is interested in interrogating. For example, the user may wish to interrogate the operating parameters of the plant 1 or installation 2 yesterday or some previous time period. A dropdown menu is provided for selecting the date and time range, as per step 406. At step 407, the system compiles the data requested by the user and displays the results on the PC 86 at step 408. The user may select how the results are displayed, and this may be by way of a graph or list at step 409. At step 410 the user is able to make annotations to that data if the user wishes. For example, an indication may be provided that the pump 20 in the settling tank 18 did not operate when the liquid level in the tank suggests that it should have. This may be known to the user and may be because of shutdown of the pump 20 for routine maintenance or the like and, if this is the case, the authorised user can annotate those results accordingly so as to provide a future record that the failure of the pump 20 was expected because of the routine maintenance and shutdown of the pump 20. At step 412 the user can decide how data is to be stored, and this can be by way of any conventional format such as CSV or JPEG or the like.

At step 413 the user has the option to view the latest real time data collected by the sensors referred to in FIGS. 1 and 2. If the user selects real time values, the server 80 is notified to select current data at step 414 and the appropriate site is polled at step 415. This therefore returns the program back to step 407 which compiles the up-to-date data and the same steps as explained with reference to steps 409 to 412 occur. Thus, the user is provided with the current data as being measured by the sensors so that the user can ascertain the exact current operating conditions of the plant 1 or installation 2 to determine if any remedial action is required if the user was prompted to interrogate the system by way of SMS message. At step 416 the user simply logs off if the user has completed the interrogation.

Thus, the system according to the preferred embodiment of the invention stores a continuous record of the data which is monitored by the system and which can be used to provide a record of events which have occurred and the remedial action which was taken to control those events. This may be used to provide a record to authorities to show that the plant 1 or installation 2 has been operated correctly and properly maintained in response to regulatory requirements or the like.

The system also provides authorised users to provide and obtain real time information as to the status of their plant 1 or installation 2 so that as soon as there is a likelihood of a problem, remedial action can be taken to ensure that the plant 1 or installation 2 is operating satisfactorily in accordance with the required regulations under which such plants or installations are required to operate.

In another embodiment (not shown) a refrigeration unit may be monitored so as to ensure that the air temperature within the refrigeration unit does not exceed a predetermined maximum temperature or go outside a predetermined temperature range so that corrective action can be taken if necessary. Such refrigeration units are commonly used in restaurants and other environments in which food products are contained and which need to be maintained at required low temperatures. If the temperature should unexpectedly rise for any predetermined time period this may cause deterioration of the foodstuffs contained within the unit which may cause illness if those food items are consumed. This embodiment would operate in the same manner as a previous embodiment except the fluid which is being measured is air temperature and the sensor would be an air temperature sensor. As in the earlier embodiments the data supplied by the sensor would be subject to predetermined rules in the monitoring system 40 and the data which is collected is stored by the server 80 in the data store 82. This provides a continuous record of temperature within the unit which may be required to satisfy regulatory authorities. Thus, measurements can be made at predetermined time periods without manual intervention and if the system 40 determines that the temperature has risen beyond a predetermined maximum temperature the alarm conditions previously mentioned can be generated. In such an embodiment the system would be the same as, for examples, FIGS. 1 and 2 except that only the temperature sensor 27 which is designed to measure air temperature is provided in the refrigeration unit. The hardware system of FIG. 2 is identical to that previously described and the rules for processing the data would relate to comparing the data to predetermined temperature profiles or levels in order to determine whether an alarm condition or remedial action is required.

In the claims which follow and in the preceding description of the invention, except where the context requires otherwise due to express language or necessary implication, the word “comprise”, or variations such as “comprises” or “comprising”, is used in an inclusive sense, ie. to specify the presence of the stated features but not to preclude the presence or addition of further features in various embodiments of the invention.

Since modifications within the spirit and scope of the invention may readily be effected by persons skilled within the art, it is to be understood that this invention is not limited to the particular embodiment described by way of example hereinabove.

1. A monitoring system for monitoring a fluid at a site, comprising:
at least one sensor for monitoring the fluid and providing data indicative of a characteristic of the fluid;
a processor associated with the site for receiving the data from the sensor and for storing the data in a storage, the processor being programmed with predetermined rules and being for applying the predetermined rules to determine if the data, and therefore the characteristic of the fluid, meets a predetermined criterion, and being for determining whether the data needs to be transmitted to a centralised control station;
a communication device for establishing a data transmission link between the processor and the centralised control station and for transmitting the data over the link so the data can be transmitted in bulk when the rules determine the data needs to be transmitted to the station;
a server and a data store at the centralised control station for receiving and storing the data for utilisation by a user over the Internet; and
an event indicator for providing an indication if the predetermined criterion is not met so remedial action can be taken.

2. The system of claim 1, wherein the event indicator comprises an alarm at the site which is activated under control of the processor if the predetermined criterion is not met.

3. The system of claim 1, wherein the processor is also for, in the event of determining that the characteristic of the fluid does not meet a predetermined criterion, transmitting data via the link to the centralised control station, and the event indicator also comprising a communication processor at the centralised control station for transmitting a message to an authorised person that the predetermined criterion has not been met.

4. The system of claim 2, wherein the event indicator comprises an audible or visual alarm which is activated to indicate that the characteristic falls outside the predetermined criterion.

5. The system of claim 3 wherein the message comprises a mobile telephone message forwarded to a mobile telephone of the person or an SMS message forwarded to the mobile telephone, or an e-mail message.

6. The system of claim 1 wherein the communication link comprises a mobile telephone data communication link.

7. The system of claim 1 wherein a plurality of sensors are provided for monitoring the fluid and providing a plurality of signals indicative of different characteristics of the fluid.

8. The system of claim 1 wherein the fluid comprises waste water in a trade-industrial waste water plant, water within a cooling system of an air conditioning plant, or air within a refrigeration system.

9. The system of claim 1 wherein the programmed rules provide that data is transmitted in bulk when the storage is 80% full.

10. A method of monitoring a fluid at a site, comprising the steps of:
monitoring the fluid with at least one sensor to provide data indicative of a characteristic of the fluid;
storing the data and processing the data at the site in accordance with predetermined rules to determine if the data, and therefore the characteristic of the fluid, meets a predetermined criterion, and for determining whether the data needs to be transmitted to a centralised control station;
establishing a data transmission link between the processor and the centralised control station and transmitting the data over the link so the data is transmitted in bulk when the rules determine the data needs to be transmitted to the station;
receiving the transmitted data with a server and a data store at the centralised control station so the data can be utilised by a user via the Internet; and
providing an event indication if the predetermined criterion is not met so remedial action can be taken.

11. The method of claim 10, wherein providing the event indication comprises generating an alarm at the site which is activated under control of the processor if the predetermined criterion is not met.

12. The method of claim 10 or claim 11, wherein in the event of determining that the predetermined criterion is not met, data is transmitted via the transmission link to the centralised control station, and the step of providing an event indication comprises transmitting from the centralised control system a message to an authorised person that the predetermined criterion has not been met, and further including the step of transmitting data via the link to the centralised control station in the event that the predetermined criterion is not met so the event indication is immediately transmitted to the person.

13. The method of claim 12, wherein the message comprises a mobile telephone message forwarded to a mobile telephone of the person or an SMS message forwarded to the mobile telephone, or an e-mail message.

14. The method of claim 10 wherein the communication link comprises a mobile telephone data communication link.

15. The method of claim 10 wherein the fluid is monitored by a plurality of sensors for providing a plurality of signals indicative of different characteristics of the fluid.

16. The method of claim 10 wherein the fluid comprises waste water in a trade-industrial waste water plant, water within a cooling system of an air conditioning plant, or air within a refrigeration system.

17. The method of claim 10 wherein the program rules provide that data is transmitted in bulk when a storage containing the data is 80% full.

18. A monitoring system for a trade/industrial waste water plant which has a collection tank for collecting waste water, a mixing tank for receiving the waste water from the collection tank and in which the pH of the waste water is adjusted, a settling tank for receiving the waste water from the mixing tank, the settling tank having a pump for pumping the waste water from the settling tank to drain, the system comprising:
a sensor for measuring the pH level of the waste water in the mixing tank or the settling tank, and for providing data indicative of the pH level;
a processor at the plant for receiving the data from the sensor and for storing the data in a storage, the processor being programmed with predetermined rules and being for applying the predetermined rules to determine if the data, and therefore the pH level, meets a predetermined criterion, and being for determining whether the data needs to be transmitted to a centralised control station;
a communication device for establishing a data transmission link between the processor and the centralised control station and for transmitting the data over the link so the data can be transmitted in bulk when the rules determine the data needs to be transmitted to the station;
a server and data store at the centralised control station for receiving and storing the data so the data can be utilised by a user via the Internet; and
an event indicator for providing an indication if the pH level does not meet the predetermined criterion so remedial action can be taken.

19. The system of claim 18 further comprising:
a sensor for measuring the water level in the settling tank and for providing data indicative of the water level;
a sensor for sensing flow from the pump and for providing data indicative of flow from the pump; and
wherein the processor receives the data from all the sensors to determine if the pH level, water level and flow meet predetermined criteria so that data relating to all the sensors is able to be transmitted to the centralised control station by the transmission link for receipt by the server and data store, and so the event indicator can provide an indication if the predetermined criterion relating to any one of the sensors is not met so remedial action can be taken.

20. The system of claim 19 wherein the plant further comprises:
a reservoir for providing an acid solution to the mixing tank;
a reservoir for providing an alkaline solution to the mixing tank; and
the system further comprises:
respective sensors for measuring the level of the solutions in the acid reservoir and alkaline reservoir and providing signals indicative of the levels;
the processor being for receiving the signals to determine whether the level of the acid solution and alkaline solution meets predetermined criteria; and
the event indicator providing an indication if the predetermined criteria are not met so that the reservoirs can be refilled if necessary.

21. The system of claim 18 wherein a first sensor is provided for measuring the pH level in the mixing tank, and a second sensor is provided for measuring the pH level in the settling tank, each for providing respective data indicative of pH level for receipt by the processor.

22. The system of claim 19 wherein the processor controls the pump so as to activate the pump to pump waste water from the settling tank when the water level in the settling tank reaches a predetermined level.

23. The system of claim 20 wherein the system also includes a temperature sensor for measuring the temperature of the waste water in the settling tank.

24. The system of claim 20 wherein the processor controls application of acid solution or alkaline solution to the mixing tank depending on the pH level of the water.

25. The system of claim 20 wherein the rules implemented by the processor include one or more of the rules selected from the following group: the temperature of the waste water, the pH level of the waste water, whether the pump is operating, the flow rate of waste water discharge by the pump, whether the central controller has made contact with the remote monitoring processor via the communication link within a specified time period, and whether the remote monitoring processor is ready to download data to the central control station.

26. The system of claim 25 wherein the event indicator provides an indication of the need to turn on or off the pump, replenish the acid solution or alkaline solution in the acid reservoir and alkaline reservoir, instigate a local alarm, transmit a message to the authorised person, and download data from the remote monitoring processor to the central controller.

27. The system of claim 18 wherein data is transmitted in bulk when the storage is 80% full.

28. A method of monitoring a trade/industrial waste water plant which has a collection tank for collecting waste water, a mixing tank for receiving the waste water from the collection tank and in which the pH of the waste water is adjusted, a settling tank for receiving the waste water from the mixing tank, the settling tank having a pump for pumping the waste water from the settling tank to drain, the method comprising the steps of:
measuring the pH level of the waste water in the mixing tank or the settling tank with a sensor, and providing data indicative of the pH level;
storing the data and processing the data at the plant in accordance with predetermined rules to determine if the data, and therefore the pH level, meets a predetermined criterion, and for determining whether the data needs to be transmitted to a centralised control station;
establishing a data transmission link between the processor and the centralised control station and transmitting the data over the link in bulk when the rules determine the data needs to be transmitted to the station;
receiving the transmitted data with a server and data store at the centralised control station so the data can be utilised by a user via the Internet; and
providing an event indication if the pH level does not meet the predetermined criterion so remedial action can be taken.

29. The method of claim 28 further comprising:
measuring the water level in the settling tank and for providing data indicative of the water level;
sensing flow from the pump and for providing data indicative of flow from the pump; and
processing the data from all the sensors to determine if the pH level, water level and flow meet predetermined criteria so that data relating to all the sensors is able to be transmitted to the centralised control station by the transmission link for receipt by the server and data store, and so the event indication is provided if the predetermined criterion relating to any one of the sensors is not met so remedial action can be taken.

30. The method of claim 29 wherein the plant further comprises:
a reservoir for providing an acid solution to the mixing tank;
a reservoir for providing an alkaline solution to the mixing tank; and
the method further comprises:
measuring the level of the solutions in the acid reservoir and alkaline reservoir and providing data indicative of the levels;
processing the data to determine whether the level of the acid solution and alkaline solution meets predetermined criteria; and
providing the event indication if the predetermined criteria are not met so that the reservoirs can be refilled if necessary.

31. The method of claim 29 wherein the pump is activated to pump waste water from the settling tank when the water level in the settling tank reaches a predetermined level.

32. The method of claim 30 further comprising measuring the temperature of the waste water in the settling tank.

33. The method of claim 30 further comprising controlling application of acid solution or alkaline solution to the mixing tank depending on the pH level of the water.

34. The method of claim 30 wherein the rules implemented by the processor include one or more of the rules selected from the following group: the temperature of the waste water, the pH level of the waste water, whether the pump is operating, the flow rate of waste water discharge by the pump, whether the central controller has made contact with the remote monitoring processor via the communication link within a specified time period, and whether the remote monitoring processor is ready to download data to the central control station.

35. The system of claim 34 wherein the event indicator provides an indication of the need to turn on or off the pump, replenish the acid solution or alkaline solution in the acid reservoir and alkaline reservoir, instigate a local alarm, transmit a message to the authorised person, and download data from the remote monitoring processor to the central controller.

36. A monitoring system for cooling towers of an air conditioning system, the monitoring system comprising:
a sensor for sensing the pH level of water in the cooling tower, and providing data indicative of the pH level;
a sensor for measuring the temperature of the water in the cooling tower, and providing data indicative of the temperature;
a sensor for measuring the conductivity of the water in the cooling tower, and providing data indicative of the conductivity;
a processor associated with towers for receiving the data from the sensors, storing the data in a storage, and for applying predetermined rules to determine whether the pH level, temperature and conductivity fall within prescribed limits, and for determining whether the data needs to be forwarded to a centralised control station;
a communication device for establishing a data transmission link between the processor and the centralised control station and for transmitting the data over the link so the data can be transmitted in bulk when the rules determine the data needs to be transmitted to the station;
a server and a data store at the centralised control station for receiving and storing the data for utilisation by a user via the Internet; and
an event indicator for providing an indication if the prescribed limits are not met so remedial action can be taken.

37. The system of claim 36 wherein the data is transmitted in bulk when the storage is 80% full.

38. A method of monitoring cooling towers of an air conditioning system, the method comprising:
sensing the pH level of water in the cooling tower, and providing data indicative of the pH level;
measuring the temperature of the water in the cooling tower, and providing data indicative of the temperature;
measuring the conductivity of the water in the cooling tower, and providing data indicative of the conductivity;
storing and processing the data at the cooling towers in accordance with predetermined rules to determine whether the pH level, temperature and conductivity fall within prescribed limits, and for determining whether the data needs to be forwarded to a centralised control station;
establishing a data transmission link between the processor and the centralised control station and transmitting the data over the link so the data can be transmitted in bulk when the rules determine the data needs to be transmitted to the station;
receiving the transmitted data by a server and a data store at the centralised control station for utilisation by a user via the Internet; and
providing an indication event if the prescribed limits are not met so remedial action can be taken.

39. The method of claim 38 wherein the data is transmitted in bulk when the storage containing the data is 80% full.

40. A monitoring system for monitoring a refrigeration unit, the monitoring system comprising:
a sensor for sensing air temperature within the unit and providing data indicative of the air temperature;
a processor at the unit for receiving the data from the sensor and for storing the data, the processor being programmed with predetermined rules and being for applying the predetermined rules to determine if the data, and therefore the air temperature, meets a predetermined criterion, and being for determining whether the data needs to be transmitted to a centralised control station;
a communication device for establishing a data transmission link between the processor and the centralised control station and for transmitting the data over the link so the data is transmitted in bulk when the rules determine the data needs to be transmitted to the station;
a server and a data store at the centralised control station for receiving and storing the data so the data can be utilised by a user via the Internet; and
an event indicator for providing an indication if the criteria is not met so remedial action can be taken.

41. The monitoring system of claim 40 wherein the data is transmitted in bulk when the storage is 80% full.

42. A method of monitoring a refrigeration unit, the method comprising:
sensing air temperature within the unit and providing data indicative of the air temperature;
storing and processing at the unit the data in accordance with predetermined rules to determine if the data, and therefore the air temperature, meets a predetermined criterion, and for determining whether the data needs to be transmitted to a centralised control station;
establishing a data transmission link between the processor and the centralised control station and transmitting the data over the link so the data is transmitted in bulk when the rules determine the data needs to be transmitted to the station;
receiving the transmitted data by a server and a data store at the centralised control station for so the data can be utilised by a user via the Internet; and
providing an event indication if the criteria is not met so remedial action can be taken.

43. The method according to claim 42 wherein the data is transmitted in bulk when the storage containing the data is 80% full.
